(19) United States
(12) Patent Application Publication
(10) Pub. No.: US 2012/0254277 A1
(43) Pub. Date: Oct. 4, 2012

(54) AGGREGATING INFORMATION OF DISTRIBUTED JOBS

(76) Inventors: Patty Peichen Ho, San Jose, CA (US); Balaji Raghunathan, Santa Clara, CA (US); Anna Stepanenko, Sunnyvale, CA (US)

(21) Appl. No.: 13/073,028

(22) Filed: Mar. 28, 2011

(51) Int. Cl. G06F 15/16

(52) U.S. Cl. 709/201

(57) ABSTRACT

Example embodiments disclosed herein relate to the aggregation of information included in messages associated with a distributed job. The messages are associated with a job identifier corresponding to the distributed job. The information can be aggregated based on the job identifier.

### BACKGROUND

Administrators often run jobs (e.g., maintenance jobs) periodically on machines the respective administrators manage. Such administrators can use programs to run the jobs over distributed systems. Maintenance on systems can be used to help provide services (e.g., e-mail, web based sales, etc.) to consumers. For example, it is beneficial to run maintenance tasks to ensure the integrity of information used by the services. Further, other jobs can be used to facilitate usage of devices for users.

### BRIEF DESCRIPTION OF THE DRAWINGS

The following detailed description references the drawings, wherein:

FIG. 1 is a system diagram of components used to aggregate message information associated with jobs distributed to multiple devices, according to one example;

FIG. 2 is a block diagram of a computing device for aggregating message information associated with distributed jobs, according to one example;

FIGS. 3A and 3B are block diagrams of devices including modules used in a distributed system, according to various examples;

FIG. 4 is a flowchart of a method for aggregating messages associated with a distributed job, according to one example; and

FIG. 5 is a flowchart of a method for presenting aggregated information associated with a distributed job, according to one example.

### DETAILED DESCRIPTION

Administrators of computing devices often run processing jobs regularly (e.g., scheduled and/or periodic) on machines they administer. In certain embodiments, a job is a unit of work that can be executed. The work can be executed at a device via an application, program, group of programs, etc. A distributed environment that includes multiple machines can be used to process jobs. Technical challenges exist in distributing and processing information associated with these jobs, for example, because the number of machines in the distributed system is large (e.g., in the order of hundreds or thousands of machines). For example, jobs can be run individually on devices of the distributed system, but without a common attribute to link the related jobs together. Further, the system may not include a scheme for processing or determining an aggregated status and/or results from related job execution. Thus, in some examples, an administrator may collect the status and results from the machines in the distributed system and aggregate the status and/or results manually.

In one example, there are 100 machines in a distributed environment and there is a need to run several different maintenance jobs periodically at different frequencies. To perform the jobs on the machines, the administrator would schedule the jobs and collect the results individually on each machine. Then the administrator could parse through the 100 result sets for each job to determine whether all of the jobs were performed successfully. These actions can be tedious and time consuming for administrators.

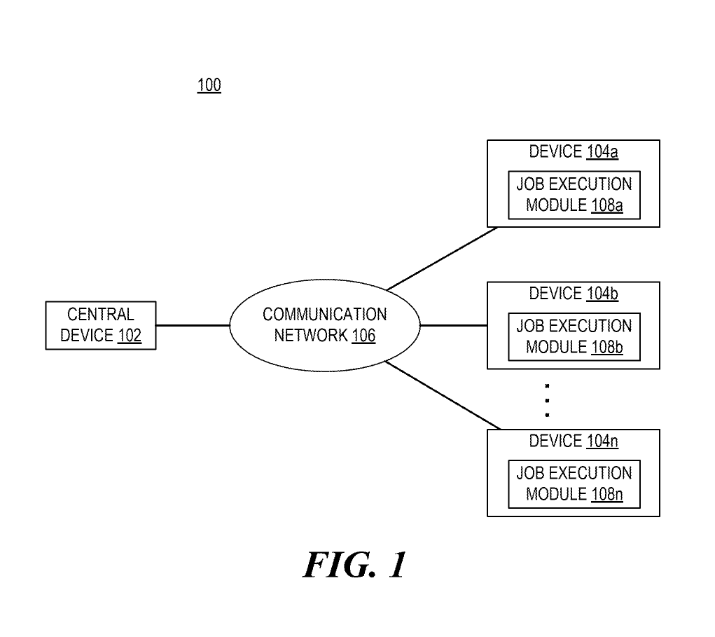

Accordingly, various embodiments disclosed herein relate to aggregating message information associated with jobs distributed to machines in a distributed system. FIG. 1 is a system diagram of components used to aggregate message information associated with jobs distributed to multiple devices, according to one example. The system 100 can include a central device 102 that communicates with devices 104a-104n via a communication network 106. In certain examples, the central device 102 and/or the devices 104a-104n are computing devices, such as servers, client computers, desktop computers, mobile computers, etc. In other embodiments, the devices 104a-104n can include special purpose machines. Further, the devices 104a-104n can include respective job execution modules 108a-108n. The central device 102 and the devices 104 can be implemented via a processing element, memory, and/or other components. Further, various architectures, such as multidimensional scalable grid based architectures, can be utilized in the implementation of the devices 104 and/or infrastructure associated with the devices 104.

The job execution module 108 can be used to execute one or more jobs. In certain embodiments, the central device 102 generates a schedule of one or more jobs that can be executed. A schedule can identify one or more jobs and corresponding times or events (e.g., a trigger time) to trigger execution of the jobs. Further, a job can be processed at multiple devices 104 as job instances. In one embodiment, a job instance is a job that is run on a particular machine that belongs to the schedule. Moreover, in one embodiment, a distributed job is a single representation of all the job instances with the same job identifier, where the job instances can be executing on different devices 104a-104n. The schedule is transmitted to the devices 104a-104n. The transmission can be based on a determination of the devices 104 that are associated with running the job instances. This can be a subset of the total devices 104a-104n in the distributed system 100.

A device 104 receives the schedule and can use a local scheduling program to process the schedule. The local scheduling program can register and utilize the schedule. The schedule can be set to trigger a distributed job at a particular time. When the job is triggered at the device 104, the scheduling program and/or the job execution module 108 of the device 104 can determine a job identifier to associate with the distributed job. Then, the job is performed via the job execution module 108. Examples of jobs that can be executed include maintenance processes such as modifying files to correct faults, to improve performance, or to modify other attributes, detecting such files, determining a status of such files, archiving e-mails, updating archived files (e.g., based on a maintenance routine), updating an index, or the like. As noted above, the distributed job can be performed similarly as instances on the devices 104a-104n.

As the job instances execute on respective job execution modules 108, the devices 104a can transmit messages, via the communication network 106, to the central device 102. The messages can be transmitted based on local scheduling information, a configuration file, or combinations thereof. The configuration file can describe the distributed job and may be received at the devices 104 from the central device 102. Further, the configuration file can include a job type, configuration parameters, result processing information (e.g., types of information to transmit back to the central device 102, how to process results, etc.), or a combination thereof. In one embodiment, a job type is a category of work that can be executed. The job type can include an identifier, a description, a priority associated with the job type, host type describing devices 104 associated with execution of the job type, combinations thereof, or the like. The configuration file can further include a status and/or result list describing what information to include in the messages. For example, the result list can include one or more result names, one or more result types (e.g., a count, a Boolean type, a percentage, text, etc.), an aggregation configuration field, combinations thereof, or the like. The configuration file can further be stored as text, a markup language (e.g., Extensible Markup Language (XML)), or formatted via another method (e.g., a table). The description of the job type can include what information to include in the messages. For example, the description can include what information (e.g., progress information) to include in messages during the distributed job. Further, the description can include what information to include in messages at the completion of the distributed job.

The central device 102 receives the messages from the devices 104. Multiple messages can be associated with a single distributed job. Further, the messages can be received from different devices 104. When received, the messages can be processed. As such, the messages can be aggregated based on a job identifier. The job identifier can be based on a name associated with the job as well as a time associated with the job. For example, the job identifier can include a timestamp of a trigger time of the job in combination with a job name, which may be the schedule name or job name that caused the triggering of the job instance. The messages can be status messages and/or result messages. An aggregated result can be determined based on the messages. For example, counts can be aggregated, percentages can be aggregated, Boolean values can be aggregated, and other status/result types can be aggregated.

In one example, a status can include text (e.g., a status field). If the job instance associated with the message is still processing, the field can include a status indicating that the job instance is running. Further, if the job instance has an error, the status message can indicate that at least one error has occurred. Moreover, if the job instance has completed successfully, the message can indicate the success. When the status is aggregated at the central device 102, the status can indicate a status of running for a distributed job if at least one associated job instance has not completed execution. Further, the aggregated status can indicate successful if the associated job instances have been completed and are determined to be successful. Moreover, the aggregated status can indicate that there is an error in at least one job instance. The job status can also be hierarchical, for example, a base job status can be at the highest level (e.g., indicating error), while more refined job statuses are provided at lower levels (e.g., indicating that 99/100 job instances indicate successful completion while 1/100 job instances indicate an error).

The communication network 106 can use wired communications, wireless communications, or combinations thereof. Further, the communication network 106 can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network 106 can be in the form of a direct network link between devices. Various communications structures and infrastructure can be utilized to implement the communication network(s). For example, grid based architectures can be used. For example, the devices 104 can be part of a server grid or a storage grid.

By way of example, the central device 102 and devices 104 communicate with each other and other components with access to the communication network 106 via a communication protocol or multiple protocols. A protocol can be a set of rules that defines how nodes of the communication network 106 interact with other nodes. Further, communications between network nodes can be implemented by exchanging discrete packets of data or sending messages. Packets can include header information associated with a protocol (e.g., information on the location of the network node(s) to contact) as well as payload information. A program or application executing on the central device 102 or the devices 104 can utilize one or more layers of communication to utilize the messages.

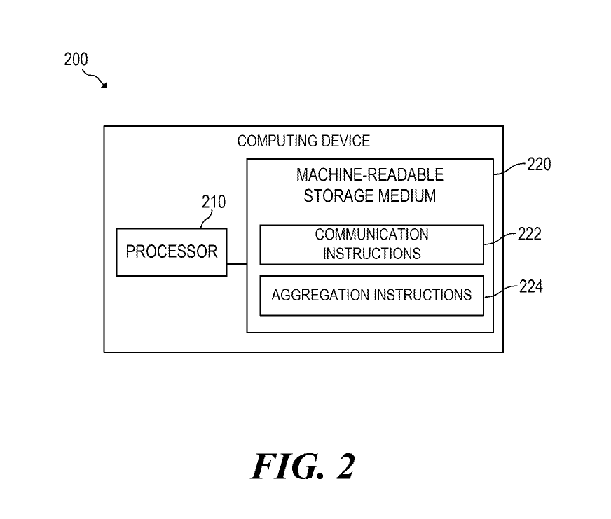

FIG. 2 is a block diagram of a computing device for aggregating message information associated with distributed jobs, according to one example. The computing device 200 includes, for example, a processor 210, and a machine-readable storage medium 220 including instructions 222, 224 for aggregating message information. Computing device 200 may be, for example, a notebook computer, a desktop computer, a server, a workstation, a slate computing device, a portable reading device, a wireless email device, a mobile phone, or any other computing device.

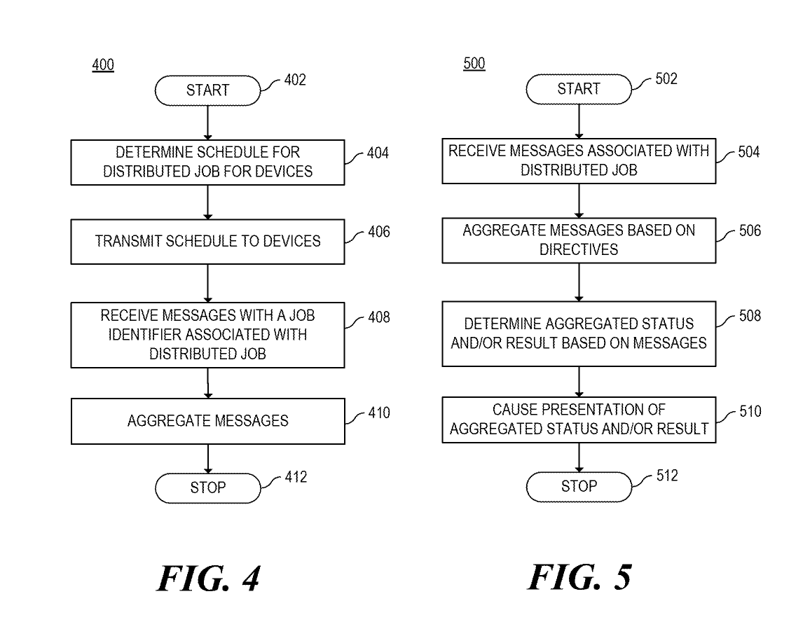

Processor 210 may be at least one central processing unit (CPU), at least one semiconductor-based microprocessor, at least one graphics processing unit (GPU), other hardware devices suitable for retrieval and execution of instructions stored in machine-readable storage medium 220, or combinations thereof. For example, the processor 210 may include multiple cores on a chip, include multiple cores across multiple chips, multiple cores across multiple devices (e.g., if the computing device 200 includes multiple node devices), or combinations thereof. Processor 210 may fetch, decode, and execute instructions 222, 224 to implement the processes, for example, the processes of FIGS. 4 and 5. As an alternative or in addition to retrieving and executing instructions, processor 210 may include at least one integrated circuit (IC), other control logic, other electronic circuits, or combinations thereof that include a number of electronic components for performing the functionality of instructions 222, 224.

Machine-readable storage medium 220 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail below, machine-readable storage medium 220 may be encoded with a series of executable instructions for aggregating job information from scheduled jobs.

Instructions stored on the machine-readable storage medium can cause the processor 210 to generate a schedule. As previously noted, the schedule can determine one or more distributed jobs. The distributed jobs can be generated based on input from a user (e.g., via a keyboard, mouse, etc.), an automated program, a directed program, or a combination thereof. The schedule for distributed jobs can be transmitted to devices for processing. As the devices process instances of the triggered distributed jobs, the devices send messages to the computing device 200.

The communication instructions 222 can use one or more input and/or output devices (e.g., a network interface device, a transceiver, etc.). As such, the communication instructions 222 can be used to receive the messages from the devices. The messages can be associated with a job identifier corresponding to a distributed job processed as job instances respectively associated with the devices. Thus, for a particular distributed job, messages can be received from the instances executing on multiple devices.

The aggregation instructions 224 can then be used to aggregate the messages based on the job identifier. As previously noted, the job identifier can be based, at least in part, on a schedule associated with the distributed job. For example, the job identifier can include a name or other identifier of the distributed job as well as scheduling information (e.g., ‘JOBNAME’ appended with a timestamp associated with a trigger based on the schedule). Because the job identifier includes time information and schedule information, the computing device 200 can identify messages to particular scheduled distributed jobs.

Further, the aggregation instructions 224 can be used to determine an aggregated status and/or an aggregated result based on the messages. Examples of an aggregated status/result include adding counts retrieved from messages associated with a particular job instance, or combining text results into an aggregated status based on criteria. Moreover, the aggregation of the messages can be based on one or more directives. In certain embodiments, a directive can be used to specify the criteria. For example, the directive can specify a manner in which the status/result information is aggregated. These directives can be passed to the devices as part of a configuration file indicating what type of information for the devices to collect from associated job instances. The messages sent from the devices can thus be based on the directives. Further, the aggregation may further be based on the directives because of the information received in the messages. For example, fields in the messages can include particular types of information about the execution of the job.

In certain scenarios, the processor 210 can be used to cause presentation of the aggregated status and/or aggregated result. The processor 210 can determine a presentation (e.g., a rendering of content) and transmit the presentation to an output device. The output device may be, for example, a display such as a Liquid Crystal Display (LCD), monitor, television, projection, or the like. The presentation can show a summary of the aggregated results per job or can be broken out into sub presentations, for example, by the devices executing the jobs. Examples of information presented can include a status indication (e.g., job succeeded, job indicates at least one error, job is still running, etc.), aggregated results (e.g., a count of errors detected, a count of errors fixed, a count of errors unfixed, a percentage of completed tasks, a number of files updated, a number of files removed, etc.), timing information, and associated device information.

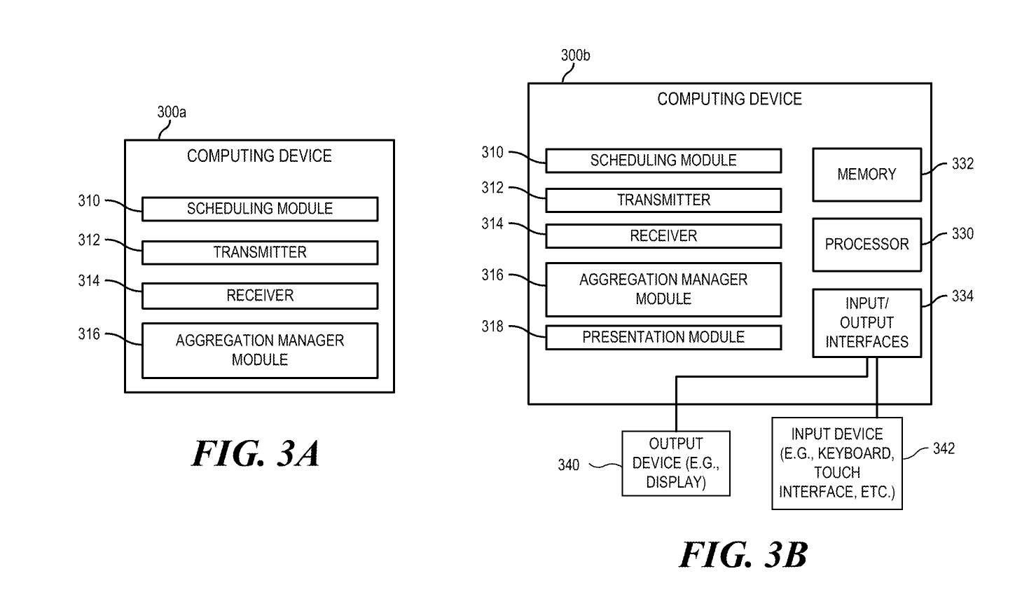

FIGS. 3A and 3B are block diagrams of devices including modules used in a distributed system, according to various examples. Further, computing devices 300a, 300b include modules that can be used to aggregate messages based on a job identifier. The respective computing devices 300a, 300b may be a notebook computer, a slate computing device, a wireless device, a mobile device, a server, or any other device that may be used as a centralized device to coordinate jobs. A processor, such as a CPU, a GPU, or a microprocessor suitable for retrieval and execution of instructions and/or electronic circuits configured to perform the functionality of any of the modules 310-318 described below. In some embodiments, the computing devices 300a, 300b can include some of the modules (e.g., modules 310-316) as shown in FIG. 3A, the modules (e.g., modules 310-318) shown in FIG. 3B, and/or additional components, such as one or more processors 330, memory 332, or one or more input/output interfaces 334.

As detailed below, computing devices 300a, 300b may include a series of modules 310-318 for aggregating message information based on a job identifier. Each of the modules 310-318 may include, for example, hardware devices including electronic circuitry for implementing the functionality described below. In addition or as an alternative, each module may be implemented as a series of instructions encoded on a machine-readable storage medium associated with respective computing devices 300a, 300b and executable by a processor. It should be noted that, in some embodiments, some modules are implemented as hardware devices, while other modules are implemented as executable instructions.

The scheduling module 310 can be used to generate a schedule of one or more jobs (e.g., distributed jobs) that can be executed. These jobs can be distributed among devices to execute the jobs. As previously noted, a schedule can identify one or more jobs and corresponding times or events to trigger execution of the jobs. Further, customized schedules can be sent to different job execution devices. For example, a customized schedule can include job information corresponding to jobs executed on the particular job execution device. Moreover, a schedule can be associated with an individual job. For example, the individual job schedule can be sent to job execution devices. The job execution devices can add the job to a local job schedule via a local scheduling program. Thus, the scheduling module can determine a schedule for a distributed job associated with a set of job execution devices.

The transmitter 312 can then be utilized to transmit the schedule(s) to the respective job execution devices of the set. Distributed jobs may include a plurality of job instances that are respectively associated with the job execution devices. As such, the schedule can include a trigger time, multiple trigger times, or information to determine one or more trigger times to trigger the distributed job as the job instances on the respective job execution devices.

As noted above, the trigger time may be used to generate a job identifier associated with the distributed job (e.g., based on an identifier associated with the distributed job type and/or schedule and the trigger time). Further, the schedule(s) can include repeating or multiple times to perform a particular type of distributed job. As such, a first distributed job with a first trigger time may be associated with a first job identifier while a second distributed job of the same type may be associated with a second trigger time and a second job identifier. Moreover, the set of job execution devices may or may not be the same for the first distributed job and the second distributed job.

When the distributed job is triggered at a job execution device, the job execution device may use a local scheduler to determine when to process the associated job instance. Thus, each of the job execution devices of the set can execute the job instances independently. These job instances may additionally be executing at different times. As such, the computing device 300 is challenged to keep track of the status of the job instances. To facilitate the processes, the job execution devices generate and send messages to the computing device 300 including status and/or result information.

The receiver 314 receives the messages from the job execution devices. The messages can be respectively associated with the job execution devices of the set. Further, the message may include an identifier of the job execution device sending the message. Moreover, the message may include the job identifier corresponding to a particular distributed job processed at the respective job execution devices.

As messages are received, or at a later time, the aggregation manager module 316 can aggregate information included in the messages. The aggregation can be based on the job identifier. The aggregation manager module 316 may determine aggregation information associated with each job identifier. As such, when a message is received, it can be parsed for the job identifier. The message can then be used to update the associated aggregation information. The aggregation information can be used to determine one or more aggregated statuses and/or results.

In certain scenarios, the presentation module 318 can be used to present the aggregated information, for example, as an aggregated status and/or an aggregated result. The presentation module 318 can determine presentation information and transmit the presentation information to a presentation device, for example, via an input/output interface 334 to an output device 340. The output device 340 can include a projector, a monitor, an LCD, a television, etc. and can be associated with other devices (e.g., a speaker) that may be used to present the presentation information. As such, the aggregated status, result, or other presentation information can be viewed by a user, for example, an administrator of a distributed system.

An input device 342 can be used to receive input from a user (e.g., an administrator) utilizing the computing device 300b. As such, the user can input scheduling information, control presentations, or the like. Examples of input devices 342 include a keyboard, a mouse, a remote, a microphone, a touch interface, etc. The computing device 300b may further include devices used for input and output (not shown), such as a touch screen interface, a networking interface (e.g., Ethernet), a wireless networking interface, or the like.

FIG. 4 is a flowchart of a method for aggregating messages associated with a distributed job, according to one example. Although execution of method 400 is described below with reference to computing device 300, other suitable components for execution of method 400 can be utilized (e.g., computing device 200). As such, computing device 300 can be considered a means for executing the method 400. Additionally, the components for executing the method 400 may be spread among multiple devices. Method 400 may be implemented in the form of executable instructions stored on a machine-readable storage medium, such as storage medium 220, and/or in the form of electronic circuitry.

Method 400 may start in 402 and proceed to 404, where computing device 300 may determine a schedule for a distributed job for a plurality of devices. The schedule can further include multiple distributed jobs and can be set up as an input for a local scheduling program executing on the respective devices.

The devices can be configured to execute respective job instances for a distributed job based on the schedule. Further, each of the job instances for the distributed job can be associated with a single job identifier. As noted above, the job identifier can be based on the job type as well as timing and/or scheduling information. Moreover, the distributed job may be described in a configuration file. This file can be resident on the devices and/or can be transmitted to the devices. The configuration file may include a job type and/or result processing information. As noted above, a job type may be a category of work to be executed and may include a description of the distributed job and/or a reference to facilitate determination of one or more instructions to execute in the corresponding job instances. Further, result processing information can include directives that are used to configure messages that the job instances return to the computing device 300.

At 406, the computing device 300 causes transmission of the schedule to the devices. The transmission can be sent via a transmitter 312 and/or other input/output interfaces 334. Separate transmissions can be used to send the schedule(s) to the devices. The devices can then execute the distributed job based on the schedule. The result processing information and/or the directives can be used by executing job instances to generate status and/or result messages to send to the computing device 300.

A receiver 314 of the computing device 300 receives a plurality of messages from the devices (at 408). The messages can include one or more statuses and/or results of one or more of the job instances associated with the distributed job. Further, the messages may be associated with a job identifier corresponding to the distributed job. Because multiple distributed jobs can be processed in parallel, the job identifier is useful to associate messages with a particular distributed job.

At 410, the aggregation manager module 316 of the computing device 300 aggregates information included in the messages based on the job identifier. The aggregation manager module 316 may generate data that aggregates information associated with the job identifier. The data can be stored in a file, for example in a structured format (e.g., a table, XML, etc.). The information can be included in one or more of the messages. Further, the information can include a status update and/or a result. Then, at 412, the method 400 stops.

FIG. 5 is a flowchart of a method for presenting aggregated information associated with a distributed job, according to one example. Although execution of method 500 is described below with reference to computing device 300, other suitable components for execution of method 500 can be used (e.g., computing device 200). Additionally, the components for executing the method 500 may be spread among multiple devices. Method 500 may be implemented in the form of executable instructions stored on a machine-readable storage medium, such as storage medium 220, and/or in the form of electronic circuitry.

Method 500 may start in 502 and proceed to 504, where computing device 300 may receive messages associated with a distributed job. The distributed job may be associated with a job identifier. Further, the distributed job can be described in a configuration file that includes a job type and result processing information. The result processing information can be used as input to determine execution of job instances associated with the distributed job. For example, the result processing information can include one or more directives to configure the received messages. In one example, the directives can instruct the job instances to include a particular result identifier field, a data field, or other information in the messages. A result identifier field can identify a type of information (e.g., a data structure type) associated with the data field. For example a particular type of table can be identified by the result identifier while the data field includes information that can be parsed based on the result identifier. Further, the directives can list a set of job results from a set of available predefined job results (e.g., counts, percentages, text results, etc. associated with the computing system). Moreover, the directives can determine when the devices send update messages. For example, a device can send an update when statuses of a job instance changes or when a new result is available. Additionally or alternatively, the device can send the update periodically or based on a time or event threshold.

At 506, the aggregation manager module 316 determines to aggregate the information included in the messages based on the directives. The aggregation could be based, for example, on the type of messages received, content received in the messages, or the like. In certain embodiments, only the information of messages associated with a particular job identifier are aggregated together. In this manner, information associated with another job identifier is aggregated separately. The aggregation of multiple jobs can occur concurrently.

Then, at 508, the aggregation manager module 316 determines an aggregated status, an aggregated result, or a combination thereof based on the messages. For example, counts of information associated with particular job instances can be aggregated into counts associated with the distributed job based on the associated job identifier. In one example, the aggregated status is considered running if at least one job instance of the distributed job has not yet completed execution. In another example, the aggregated status is marked as successful if each of the job instances has been completed and is determined to be successful. A job instance can be determined to be successful if the job instance completed without a processing error (e.g., lack of access to particular information). In yet another example, the aggregated status can indicate an error of at least one job instance (e.g., not enough space for execution of the job instance). Further, various types of reports can be generated. For example, the aggregated status and/or result may be customized to report a count, an average, an aggregation by maximum value of count, etc.

At 510, the presentation module 318 causes presentation of the aggregated status, the aggregated result, or a combination thereof. Table 1 includes an example of individual job statuses associated with a particular job identifier.

TABLE 1

| HOST | START | END | | |
|---|---|---|---|---|
| IPS | TIME | TIME | STATUS | JOB RESULTS |
| IP1 | TIME 1S | TIME 1E | SUCCEEDED | UNFIXABLE MISSING BITFILES = 0 |
| | | | | BITFILES NOT FIXED = 0 |
| | | | | UNFIXABLE CORRUPTED BITFILES = 0 |
| | | | | BITFILES FIXED = 0 |
| IP2 | TIME 2S | TIME 2E | SUCCEEDED | UNFIXABLE MISSING BITFILES = 0 |
| | | | | BITFILES NOT FIXED = 0 |
| | | | | UNFIXABLE CORRUPTED BITFILES = 0 |
| | | | | BITFILES FIXED = 1 |
| IP3 | TIME 3S | TIME 3E | RUNNING | UNFIXABLE MISSING BITFILES = 0 |
| | | | | BITFILES NOT FIXED = 0 |
| | | | | UNFIXABLE CORRUPTED BITFILES = 0 |
| | | | | BITFILES FIXED = 2 |

Table 1 shows a list of individual job instances based on a descriptor of an associated device (e.g., the host Internet Protocol (IP)). Each device can include associated timing information, status information, as well as job details. The timing information can include a start time (e.g., when the job instance begins executing on the particular device based on local timing and/or scheduling information and an end time. In certain scenarios, the end time can indicate that the device is still running the job instance. As such, the status reflects that the third device is still running the job instance. The job details field can provide aggregated results. In the example of Table 1, four types of results are provided as counts. The status can indicate an error or failure if a particular type of count is found (e.g., an unfixable count). Further, the status can indicate a failure if the job instance is unable to complete (e.g., based on a lack of access).

Table 2 includes an example of an aggregated job status and results.

TABLE 2

| | | HOST | START | AGGREGATED | |
|---|---|---|---|---|---|
| JOB ID | JOB TYPE | IP(S) | TIME | STATUS | AGGREGATED RESULTS |
| SCH_TIME | GROUP | IP1, | TIME1 | SUCCEEDED | UNFIXABLE MISSING BITFILES = 0 |
| | RECONCILIATION | IP2, | | | BITFILES NOT FIXED = 0 |
| | TOOL | IP3 | | | UNFIXABLE CORRUPTED BITFILES = 0 |
| | | | | | BITFILES FIXED = 3 |

Table 2 includes a job identifier field. A job identifier can include a reference to a particular schedule used to initiate the distributed job. Further, in this example, the job can be executed on three devices, IP1, IP2, and IP3. Three devices are used in this scenario for explanatory purposes, it is contemplated that additional devices can be used. The start time can be determined based on a trigger time of the job or based on a processing of start times of individual job instances (e.g., the first started job instance). Further, the status can be an aggregate of the status of each of the devices. In this example the status represents succeeded because the job instances have been completed and there were no errors. In this table, the aggregated results show counts representing job instance processing information including a representation of all three of the devices associated with the job identifier. At 512, the method 500 stops.

With the above approaches a centralized machine can be used to schedule distributed jobs and collect results from the distributed jobs. This approach may facilitate management of distributed jobs for an administrator. Further, because scheduling engines can run on separate devices executing jobs, centralized machine is more able to focus on results. Moreover, the user (e.g., administrator) is able to assign directives to define results that can be aggregated. As such, the user can be presented with a quick summary of job instances for a particular device and/or job, saving the user time.

What is claimed is:

1. A method comprising:
determining a schedule for a distributed job for a plurality of devices;
transmitting the schedule to the devices;
receiving a plurality of messages associated with a job identifier corresponding to the distributed job processed at the devices, wherein the messages are respectively associated with the devices; and
aggregating information included in the messages based on the job identifier.

2. The method of claim 1, wherein the distributed job includes a plurality of job instances associated with the job identifier, and wherein the job instances are respectively associated with the devices.

3. The method of claim 2, further comprising:
determining an aggregated status based on the messages.

4. The method of claim 3, wherein the aggregated status indicates running if at least one of the job instances has not completed execution.

5. The method of claim 3, wherein the aggregated status indicates successful if each of the job instances has been completed and is determined to be successful.

6. The method of claim 3, wherein the aggregated status indicates an error of at least one job instance.

7. The method of claim 1, wherein the distributed job is described in a configuration file including a job type and result processing information.

8. The method of claim 7, wherein the result processing information includes directives to configure the respective messages, wherein the messages include a result identifier field and a data field.

9. The method of claim 8, further comprising:
determining to aggregate the information based on the directives;
determining an aggregated status, an aggregated result, or a combination thereof based on the messages; and
causing presentation of the aggregated status, the aggregated result, or a combination thereof.

10. A device comprising:
a scheduling module to determine a schedule for a distributed job associated with a set of devices;
a transmitter to transmit the schedule to the respective devices of the set;
a receiver to receives a plurality of messages,
wherein the messages are respectively associated with the devices of the set, and
wherein the messages are associated with a job identifier corresponding to the distributed job processed at the respective devices of the set; and
an aggregation manager module to aggregate information included in the messages based on the job identifier.

11. The device of claim 10, wherein the distributed job includes a plurality of job instances respectively associated with the devices, and wherein a trigger time is scheduled to trigger execution of the job instances on the respective devices.

12. The device of claim 11, wherein the job identifier is based on an identifier associated with the schedule and the trigger time.

13. A non-transitory machine-readable storage medium storing instructions that, if executed by a processor of a device, cause the processor to:
receive a plurality of messages from a plurality of devices,
wherein the messages are associated with a job identifier corresponding to a distributed job processed via a plurality of job instances respectively associated with the devices; and
aggregate information included in the messages based on the job identifier,
wherein the job identifier is based, at least in part, on a schedule associated with the distributed job.

14. The non-transitory machine-readable storage medium of claim 13, further comprising instructions that, if executed by the processor, cause the processor to:
determine an aggregated status based on the messages.

15. The non-transitory machine-readable storage medium of claim 13, further comprising instructions that, if executed by the processor, cause the processor to:
determine to aggregate the information included in the messages based on one or more directives;
determine an aggregated status, an aggregated result, or a combination thereof based on the messages; and
cause presentation of the aggregated status, the aggregated result, or a combination thereof.
